(19) United States
(12) Patent Application Publication
(10) Pub. No.: US 2024/0256994 A1
(43) Pub. Date: Aug. 1, 2024

(54) NEURAL NETWORK FOR RULE MINING AND AUTHORING

(71) Applicant: INTERNATIONAL BUSINESS MACHINES CORPORATION, Armonk, NY (US)

(72) Inventors: Ketan Gupta, Dera Bassi (IN); Santosh Suryawanshi, Pune (IN); Keerthana Sharath, Bangalore (IN); Karthick Ramanujam, Chennai (IN)

(21) Appl. No.: 18/162,597

(22) Filed: Jan. 31, 2023

(51) Int. Cl. G06Q 10/063; G06N 3/042; G06N 3/08

(52) U.S. Cl. CPC G06Q 10/063; G06N 3/042; G06N 3/08

(57) ABSTRACT

A computer-implemented process for automatically generating business rules to be employed by a business rule management system includes the following operations. A plurality of external data sources from which to receive data updates are identified. A data update relevant to a collection of business rules is obtained from at least one of the plurality of external data sources. Using a contextual analysis engine, a contextual analysis the data update is performed. Using a machine learning engine and based upon the contextual analysis of the data update, an update to the collection of business rules is generated to form an updated collection of business rules. The machine learning engine is modified based upon feedback received on the update to the collection of business rules. The updated collection of business rules is forwarded to the business rule management system.

### BACKGROUND

The present invention relates to machine learning, and more specifically, to training a neural network model for automatically generating rules.

Business rules management systems (BRMSs) are comprehensive decision-management platforms that allow organizations to create, manage and implement scalable business rules across the enterprise. BRMSs help to analyse, author, automate, and govern the rules-based business decisions. A BRMS offers tools to facilitate the entire business rules lifecycle, from defining and storing rules as formal business logic to auditing existing rules and managing the overarching decision logic that guides automation across the entire enterprise technology ecosystem. A technical advantage of a BRMS for automation efforts is that rules do not have to be separately coded into each business application. Rather, a BRMS allows an enterprise to maintain a single source of business rules such as on-premises or in a cloud. Other applications in the technology ecosystem can then draw their rules from the BRMS, which makes business rules scalable in that they only have to be created once, and any department/workflow can use them.

By way of example, a business process such as responding to a help-desk ticket can entail correctly making numerous decisions along the way: can a chatbot handle this ticket, or does it require human intervention? If an employee needs to intervene, what process should they follow? For a business process as a whole to be intelligently automated, each of these individual decisions should be automated. Moreover, the various factors that can influence these decisions—from industry regulations to market conditions and individual customer preferences—should be accounted for. BRMSs are configured to give enterprises the ability to define, deploy and manage business rules and decision logic so that applications can make smart decisions consistently, quickly and with minimal human intervention. BRMSs turn the rules that govern business decisions into enterprise-wide assets that can be leveraged in workflows across an organization.

BRMSs employ business rules as part of their implementation. Business rules are the logical guidelines used to ensure that a business decisions lead to the right outcomes. Specifically, business rules dictate what business activity should occur under which circumstances. Formally, a business rule is composed of two fundamental elements: (i) a condition, which outlines the situation in which an action should occur, and (ii) the action, which defines the thing that should happen in response to the given condition.

One issue with automating business rule generation is that the rules can be based upon information outside of the enterprise for which the rules apply. For example, the business rules may be based upon guidance/rules published by regulatory agencies. If the regulatory guidance/rules are updated/added to, the business rules relying upon this information will also have to be updated. Consequently, there will be a need to updates the rules in the BRMS.

Oftentimes, human intelligence and efforts are required to author/modify the rules. Moreover, this authoring/modifying the rules may require domain-specific knowledge and technical skills and is highly time-consuming. Additionally, the highly frequent nature of regulatory updates makes this task resource-intensive with a low return on investment. Thus, there is a need to generate/update business rules with minimal human intervention.

### SUMMARY

A computer-implemented process for automatically generating business rules to be employed by a business rule management system includes the following operations includes the following operations. A plurality of external data sources from which to receive data updates are identified. A data update relevant to a collection of business rules is obtained from at least one of the plurality of external data sources. Using a contextual analysis engine, a contextual analysis of the data update is performed. Using a machine learning engine and based upon the contextual analysis of the data update, an update to the collection of business rules is generated to form an updated collection of business rules. The machine learning engine is modified based upon feedback received on the update to the collection of business rules. The updated collection of business rules is forwarded to the business rule management system.

In other aspects of the process, the update to the collection of business rules includes a modification to a preexisting business rule. In addition to or alternatively, the update to the collection of business rules includes a creation of a new business rule. The contextual analysis can include performing, using a natural language processing engine, natural language processing on the data update. The updated collection of business rules are implemented using a business process management system. The plurality of external data sources can include a website, and the obtaining the data update includes crawling the website for the data update. In addition to or alternatively, the obtaining the data update includes receiving an electronic document from at least one of the plurality of external data sources. The feedback can include an indication as to whether the update to the collection of business rules is approved.

A computer hardware system for automatically generating business rules to be employed by a business rule management system includes the following operations includes a hardware processor configured to perform the following operations. A plurality of external data sources from which to receive data updates are identified. A data update relevant to a collection of business rules is obtained from at least one of the plurality of external data sources. Using a contextual analysis engine, a contextual analysis of the data update is performed. Using a machine learning engine and based upon the contextual analysis of the data update, an update to the collection of business rules is generated to form an updated collection of business rules. The machine learning engine is modified based upon feedback received on the update to the collection of business rules. The updated collection of business rules is forwarded to the business rule management system.

In other aspects of the hardware system, the update to the collection of business rules includes a modification to a preexisting business rule. In addition to or alternatively, the update to the collection of business rules includes a creation of a new business rule. The contextual analysis can include performing, using a natural language processing engine, natural language processing on the data update. The updated collection of business rules are implemented using a business process management system. The plurality of external data sources can include a website, and the obtaining the data update includes crawling the website for the data update. In addition to or alternatively, the obtaining the data update includes receiving an electronic document from at least one of the plurality of external data sources. The feedback can include an indication as to whether the update to the collection of business rules is approved.

A computer program product includes a computer readable storage medium having stored therein program code for automatically generating business rules to be employed by a business rule management system includes the following operations. The program code, which when executed by computer hardware system, cause the computer hardware system to perform the following. A plurality of external data sources from which to receive data updates are identified. A data update relevant to a collection of business rules is obtained from at least one of the plurality of external data sources. Using a contextual analysis engine, a contextual analysis of the data update is performed. Using a machine learning engine and based upon the contextual analysis of the data update, an update to the collection of business rules is generated to form an updated collection of business rules. The machine learning engine is modified based upon feedback received on the update to the collection of business rules. The updated collection of business rules is forwarded to the business rule management system.

In other aspects of the computer program product, the update to the collection of business rules includes a modification to a preexisting business rule. In addition to or alternatively, the update to the collection of business rules includes a creation of a new business rule. The contextual analysis can include performing, using a natural language processing engine, natural language processing on the data update. The updated collection of business rules are implemented using a business process management system. The plurality of external data sources can include a website, and the obtaining the data update includes crawling the website for the data update. In addition to or alternatively, the obtaining the data update includes receiving an electronic document from at least one of the plurality of external data sources. The feedback can include an indication as to whether the update to the collection of business rules is approved.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 is a flowchart of a typical reinforcement learning (RL) approach.

FIGS. 2A and 2B are block diagrams respectively schematically illustrating a reinforcement learning (RL) architecture and a deep Q-learning (DQN) architecture.

FIG. 3 is a block diagram illustrating an architecture of an example automated rule generation system according to at least one embodiment of the present invention.

FIG. 4 illustrates an example method using the architecture of FIG. 3 according to at least one embodiment of the present invention.

FIG. 5 is a block diagram illustrating an example of computer environment for implementing the methodology of FIGS. 1 and 4.

### DETAILED DESCRIPTION

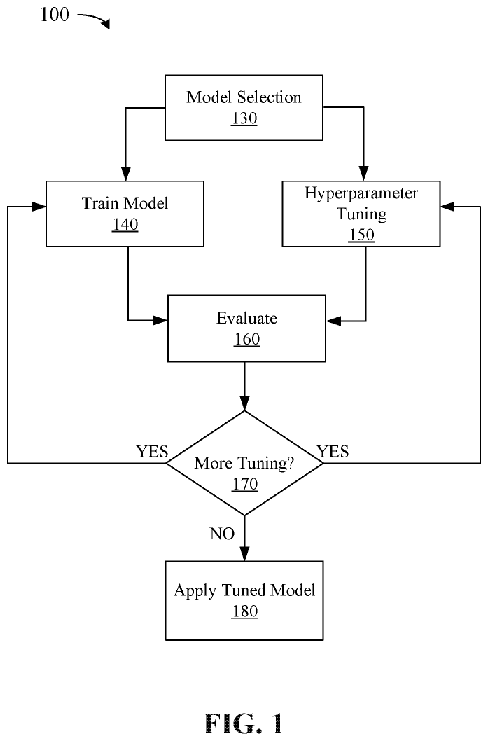

With reference to FIG. 1, a generic process 100 for machine learning is disclosed. In 130, the model to be trained is selected. There are a number of known models that can be used with machine learning. A non-exclusive list of these models includes linear regression, Deep Neural Networks (DNN), logistic regression, and decision trees. Depending upon the type of solution needed for a particular application, one or more models may be better suited.

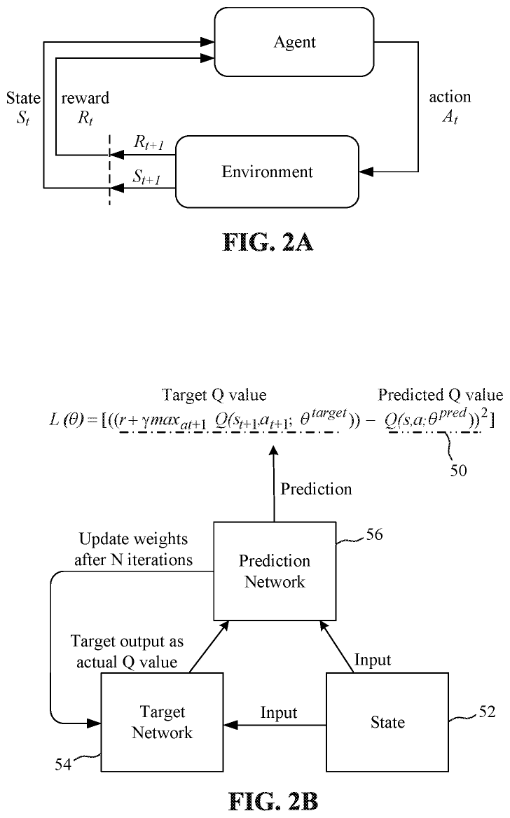

In 140, the parameters of the model are tuned. There are many different types of known techniques used to train a model. Some of these techniques are discussed in further detail with regard to FIGS. 2A-2B. In 150, hyperparameters can be tuned. Hyperparameters are variables that govern the training process itself and differ from input data (i.e., the training data) and the parameters of the model. Examples of hyperparameters include, for example, the number of hidden layers in a DNN between the input layer and the output layer. Other examples include number of training steps, learning rate, and initialization values. In certain instances, the validation dataset can be used as part of this tuning process. Although illustrated as being separate from the tuning of the parameters of model in 150, the tuning of the hyperparameters can be performed in parallel with or in series with the tuning of the parameters of the model in 140.

In 160, the parameters of the model and the hyperparameters are evaluated. This typically involves using some metric or combination of metrics to generate an objective descriptor of the performance of the model. The evaluation typically uses data that has yet to be seen by the model (e.g., new interactions with the environment). The operations of 140-160 continue until a determination, in 170, that no additional tuning is to be performed. In 180, the tuned model can then be applied to real-world data.

FIGS. 2A and 2B are block diagrams respectively illustrating a reinforcement learning (RL) architecture and a deep Q-learning (DQN) architecture for training a model. Machine learning paradigms include supervised learning (SL), unsupervised learning (UL), and reinforcement learning (RL). RL differs from SL by not requiring labeled input/output pairs and not requiring sub-optimal actions to be explicitly corrected. FIG. 2A schematically illustrates a generic RL approach. In describing RL, the following terms are oftentimes used. The “environment” refers to the world in which the agent operates. The “State” (Sₜ) refers to a current situation of the agent. Each State (Sₜ) may have one or more dimensions that describe the State. The “reward” (Rₜ) is feedback from the environment (also illustrated as “r” in FIG. 2B), which is used to evaluate actions (Aₜ) taken by the agent.

A reward function, which is part of the environment, generates the reward (Rₜ), and the reward function reflects the desired goal of the model being trained. The “policy” (π) is a methodology by which to map the State (Sₜ) of the agent to certain actions (Aₜ). Formally, the policy π(s) is defined as the suggested action (or a probably distribution of actions) that the agent should take for every possible state s∈S. The “value” is a future reward received by an agent by taking an action (Aₜ) in a particular State (Sₜ). Ultimately, the goal of the agent is to generate actions (Aₜ) that maximize the reward function.

Examples of RL algorithms that may be used include Markov decision process (MDP), Monte Carlo methods, temporal difference learning, Q-learning, Deep Q Networks (DQN), State-Action-Reward-State-Action (SARSA), a distributed cluster-based multi-agent bidding solution (DCMAB), and the like. FIG. 2B illustrates one example of the operation of a DQN model. DQN is a combination of deep learning (i.e., neural network based) and reinforcement learning. Deep learning is another subfield of machine learning that involves artificial neural networks. An example of a computer system that employs deep learning is IBM's Watson. While the terms “neural network” and “deep learning” are oftentimes used interchangeably, by popular convention, deep learning (e.g., with a DNN), refers to a neural network with more than three layers inclusive of the inputs and the output. A neural network with just two or three layers is considered just a basic neural network.

A neural network can be seen as a universal functional approximator that can be used to replace the Q-table used in Q-learning. In a DQN model, the loss function 50 is represented as a squared error of the target Q value and prediction Q value. Error is minimized by optimizing the weights, θ. In DQN, two separate networks (i.e., target network 54 and prediction network 56 having the same architecture) can be respectively employed to estimate target and prediction Q values based upon state 52. The result from the target model is treated as a ground truth for the prediction network 56. The weights for the prediction network 56 get updated every iteration and the weights of the target network 54 get updated with the prediction network 56 after N iterations.

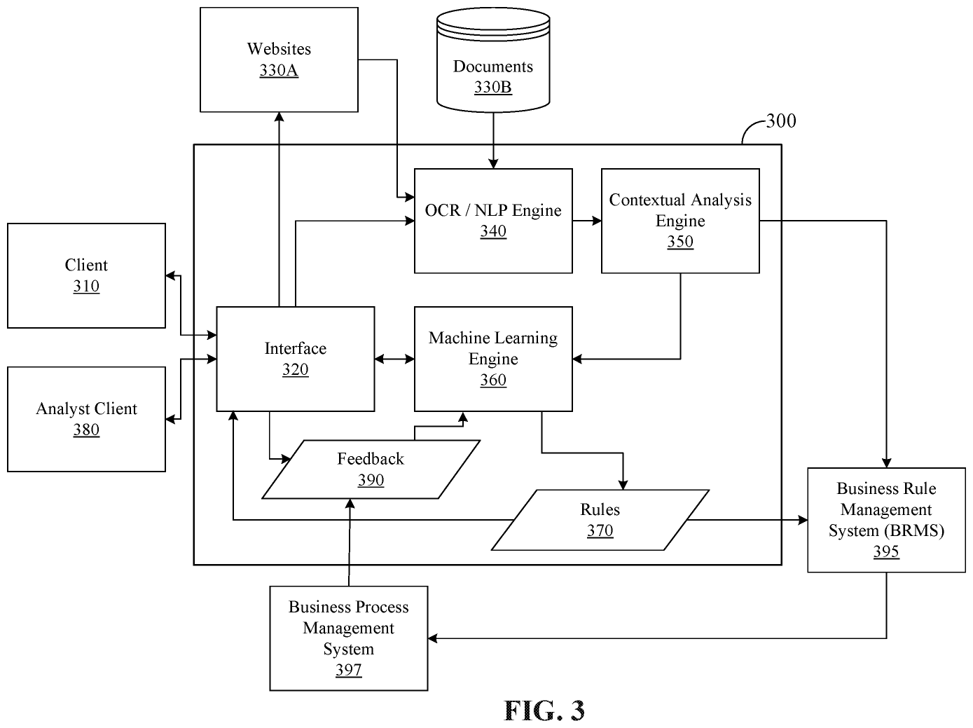

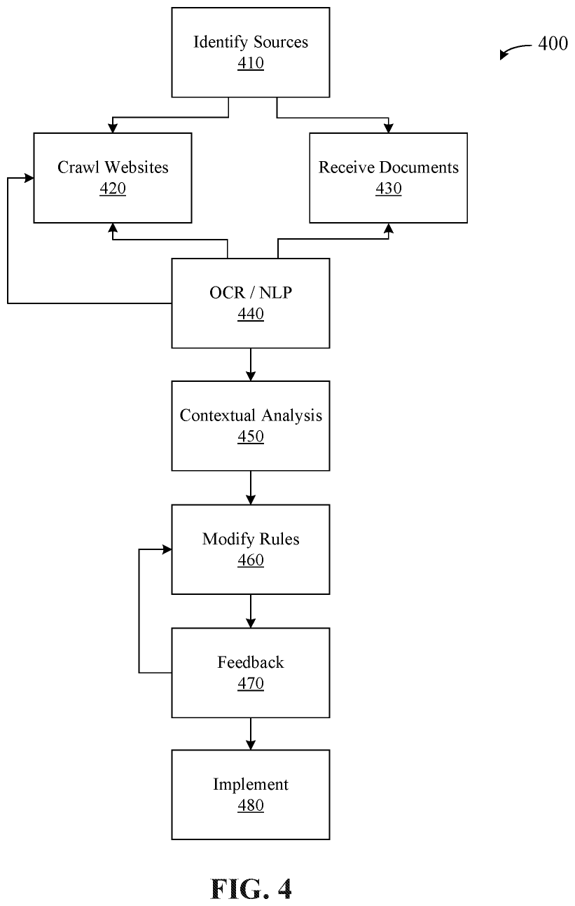

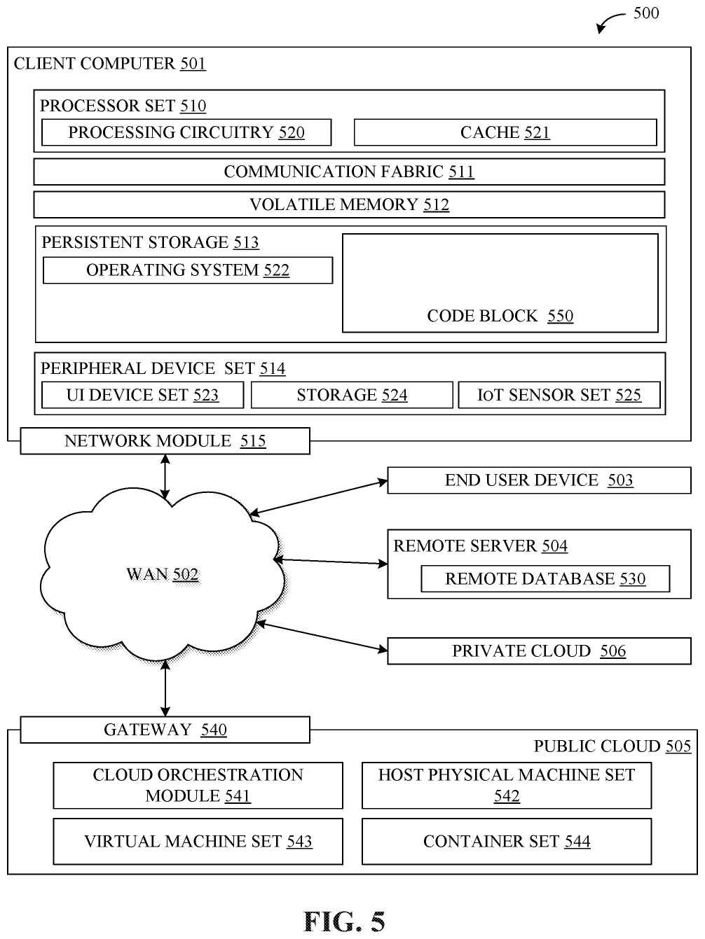

Reference is made to FIGS. 3 and 4, which respectively illustrate an automated rule generation system 300 and methodology 400 for using a neural network (as illustrated in FIGS. 2A-B) for mining and authoring business rules. The proposed automated rule generation system 300 and methodology 400 improves the process of automatically generating business rules based upon dynamically-changing external information. Although not limited in this manner, the automated rule generation system 300 includes a application programming interface (API) 320 configured to interact with a client device 310. Although illustrated as being within a single system 300, the individual components 320, 340, 350, 360 of the automated rule generation system 300 can be distributed over a plurality of computer devices. Additionally, the machine learning engine 360 could be within a standalone computer system (not shown) or located in a cloud computing system such as described in FIG. 5.

As discussed in more detail below, the automated rule generation system 300 is configured to automatically generate business rules 370 and subsequently dynamically update the business rules to be employed by a business rule management system 395. A plurality of external data sources 300A, 300B from which to receive data updates are identified. A data update relevant to a collection of business rules 370 is obtained from at least one of the plurality of external data sources 300A, 300B. Using a contextual analysis engine 350, a contextual analysis of the data update is performed. Using a machine learning engine 360 and based upon the contextual analysis of the data update, an update to the collection of business rules 370 is generated to form an updated collection of business rules 370. The machine learning engine 360 is modified based upon feedback 390 received on the update to the collection of business rules 370. The updated collection of business rules 370 is forwarded to the business rule management system 395.

Referring to process 400, in 410, using client device 310 interacting with the interface 320 of the automated rule generation system 300, a user can identify one or more external data sources 330A, 300B that contain information associated with business rule(s) 370 to be implemented using the business rule management system 395. For example, the external data sources can include websites 330A, and the manner by which these websites 330A are identified is not limited to a particular approach. For example, the client device 310 may be configured to allow for the selection of individual websites 330A and/or just select portions of the websites 330A.

In 420, based upon the identification in 410, websites 330A associated with the business rule(s) 370 are crawled to identify rule changes and/or implementations of new rules. Many types of web crawlers capable of crawling websites 330A are known, and the automated rule generation system 300 is not limited as to a particular type of web crawler. In 430, documents related associated with the business rule(s) 370 are received from a document source 330B. The documents being received are not limited to a particular type. For example, the documents could be circulated in the form of an e-mail or a paper document.

In 440, the received document(s) and/or website(s) being crawled are processed using the OCR/NLP engine 340. The OCR/NLP engine 340 is configured to perform natural language processing (NLP) and/or optical character recognition (OCR) on the received document(s) and/or website(s) being crawled. Performing OCR is typically needed for printed paper documents or image files of documents that do not include machine-encoded text. The OCR conversion of the textual content in the documents can be used in scenarios in which the documents/instructions are provided in form of the free flowing text. The result of OCR is machine-encoded text that can be subsequently processed using NLP. Although the OCR/NLP engine 340 is not limited in this manner, in certain aspects, the NLP process involves breaking down the machine-encoded text into tokens/elements and discerning particular meaning for each token/element. The OCR/NLP engine 340 can also be configured to retrieve concepts, data points, probable interpretations and their relationships. Devices capable of perform NLP and OCR are well known, and the present automated rule generation system 300 is not limited to a particular device(s) so capable. In certain aspects, one or more aspects of the OCR/NLP engine 340 can be part of the machine learning engine 360.

In 450, a contextual analysis is performed of the machine-encoded text using the context analysis engine 350. Although not limited in this manner, the context analysis can include identifying what portions of the received document(s) and/or website(s) being crawled includes new information and/or modified information. For example, if a regulation previously stated that 7-days' notice was required before a particular action could be taken and the new regulation stated that a 3-days' notice was required, the contextual analysis would identify both the particular rule and the modification to the rule. Also, the contextual analysis would identify if this particular rule (from the regulation) was previously associated with a previously-existing business rule. Alternatively, if the regulation stated that a 14-days' notice was required before performing a different action and this was a new rule, the contextual analysis would identify both the particular rule (from the regulation) as well as any potential business rule to which this particular rule could be associated. The contextual analysis engine 350 can be configured to map current data points to a new rule and/or match the data points with the existing rules, such as for amending additional clauses. The contextual analysis engine 350 can also be configured to create a completely new rule which would be part of an execution hierarchy or to provide new exception workflow branches for existing rules 370 where the context could be used to create handling mechanisms.

In 460, the machine learning engine 370 generates new rules and/or modifies existing rules 360 or create an exception workflow based upon the contextual analysis consistent with the discussion regarding FIGS. 1 and 2A-2B. In 470, the rules 370 generated by the machine learning engine 360 are provided to an analyst client device 380. Although illustrated as being separate from client device 310, these can be the same. Using the analyst client device 380, a business analyst can review and approve the newly-generated and/or modified rules 370. Based upon the amount of the rules 370, a relevance score is generated as feedback 390 to the machine learning engine 360. The relevance score can also be based upon any modifications to the rules 370 generated by the business analyst using the analyst client device 380.

In certain aspects, feedback 390 can also be received from a business process management (BPM) system 397. While a business rule management system (BRMS) 395 system is used to generate/author business rules, a BPM system 397 is the technology that is used to deploy, implement, and manage business rules. In this instance, the BPM system 397 can be configured to provide feedback 370 based upon how the business rules are actually implemented.

In 480, the rules 370 are implemented. Specifically, the automated rule generation system 100 forwards the rules 370 generated by the machine learning system 360 to the BRMS 395. Although illustrated as being separated from the automated rule generation system 100, in certain aspects, one or more portions of the BRMS 395 may be included within the automated rule generation system 100. In addition to or alternatively, one or more portions of the automated rule generation system 100 can be included within the BRMS 395.

As defined herein, the term “responsive to” means responding or reacting readily to an action or event. Thus, if a second action is performed “responsive to” a first action, there is a causal relationship between an occurrence of the first action and an occurrence of the second action, and the term “responsive to” indicates such causal relationship.

As defined herein, the term “real time” means a level of processing responsiveness that a user or system senses as sufficiently immediate for a particular process or determination to be made, or that enables the processor to keep up with some external process.

As defined herein, the term “automatically” means without user intervention.

Referring to FIG. 5, computing environment 500 contains an example of an environment for the execution of at least some of the computer code involved in performing the inventive methods, such as code block 550 for an automated rule generation system. Computing environment 500 includes, for example, computer 501, wide area network (WAN) 502, end user device (EUD) 503, remote server 504, public cloud 505, and private cloud 506. In certain aspects, computer 501 includes processor set 510 (including processing circuitry 520 and cache 521), communication fabric 511, volatile memory 512, persistent storage 513 (including operating system 522 and method code block 550), peripheral device set 514 (including user interface (UI), device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

Computer 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. However, to simplify this presentation of computing environment 500, detailed discussion is focused on a single computer, specifically computer 501. Computer 501 may or may not be located in a cloud, even though it is not shown in a cloud in FIG. 5 except to any extent as may be affirmatively indicated.

Processor set 510 includes one, or more, computer processors of any type now known or to be developed in the future. As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In certain computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods discussed above in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in code block 550 in persistent storage 513.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Communication fabric 511 is the signal conduction paths that allow the various components of computer 501 to communicate with each other. Typically, this communication fabric 511 is made of switches and electrically conductive paths, such as the switches and electrically conductive paths that make up busses, bridges, physical input/output ports and the like. Other types of signal communication paths may be used for the communication fabric 511, such as fiber optic communication paths and/or wireless communication paths.

Volatile memory 512 is any type of volatile memory now known or to be developed in the future. Examples include dynamic type random access memory (RAM) or static type RAM. Typically, the volatile memory 512 is characterized by random access, but this is not required unless affirmatively indicated. In computer 501, the volatile memory 512 is located in a single package and is internal to computer 501. In addition to alternatively, the volatile memory 512 may be distributed over multiple packages and/or located externally with respect to computer 501.

Persistent storage 513 is any form of non-volatile storage for computers that is now known or to be developed in the future. The non-volatility of the persistent storage 513 means that the stored data is maintained regardless of whether power is being supplied to computer 501 and/or directly to persistent storage 513. Persistent storage 513 may be a read only memory (ROM), but typically at least a portion of the persistent storage 513 allows writing of data, deletion of data and re-writing of data. Some familiar forms of persistent storage 513 include magnetic disks and solid state storage devices. Operating system 522 may take several forms, such as various known proprietary operating systems or open source Portable Operating System Interface type operating systems that employ a kernel. The code included in code block 550 typically includes at least some of the computer code involved in performing the inventive methods.

Peripheral device set 514 includes the set of peripheral devices for computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet.

In various aspects, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some aspects, storage 524 may take the form of a quantum computing storage device for storing data in the form of qubits. In aspects where computer 501 is required to have a large amount of storage (for example, where computer 501 locally stores and manages a large database) then this storage 524 may be provided by peripheral storage devices designed for storing very large amounts of data, such as a storage area network (SAN) that is shared by multiple, geographically distributed computers. Internet-of-Things (IoT) sensor set 525 is made up of sensors that can be used in IoT applications. For example, one sensor may be a thermometer and another sensor may be a motion detector.

Network module 515 is the collection of computer software, hardware, and firmware that allows computer 501 to communicate with other computers through a Wide Area Network (WAN) 502. Network module 515 may include hardware, such as modems or Wi-Fi signal transceivers, software for packetizing and/or de-packetizing data for communication network transmission, and/or web browser software for communicating data over the internet. In certain aspects, network control functions and network forwarding functions of network module 515 are performed on the same physical hardware device. In other aspects (for example, aspects that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515.

WAN 502 is any Wide Area Network (for example, the internet) capable of communicating computer data over non-local distances by any technology for communicating computer data, now known or to be developed in the future. In some aspects, the WAN 502 ay be replaced and/or supplemented by local area networks (LANs) designed to communicate data between devices located in a local area, such as a Wi-Fi network. The WAN 502 and/or LANs typically include computer hardware such as copper transmission cables, optical transmission fibers, wireless transmission, routers, firewalls, switches, gateway computers and edge servers.

End user device (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In certain aspects, EUD 503 may be a client device, such as thin client, heavy client, mainframe computer, desktop computer and so on.

As defined herein, the term “client device” means a data processing system that requests shared services from a server, and with which a user directly interacts. Examples of a client device include, but are not limited to, a workstation, a desktop computer, a computer terminal, a mobile computer, a laptop computer, a netbook computer, a tablet computer, a smart phone, a personal digital assistant, a smart watch, smart glasses, a gaming device, a set-top box, a smart television and the like. Network infrastructure, such as routers, firewalls, switches, access points and the like, are not client devices as the term “client device” is defined herein. As defined herein, the term “user” means a person (i.e., a human being).

Remote server 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504. As defined herein, the term “server” means a data processing system configured to share services with one or more other data processing systems.

Public cloud 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

VCEs can be stored as “images,” and a new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 506 is similar to public cloud 505, except that the computing resources are only available for use by a single enterprise. While private cloud 506 is depicted as being in communication with WAN 502, in other aspects, a private cloud 506 may be disconnected from the internet entirely (e.g., WAN 502) and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this aspect, public cloud 505 and private cloud 506 are both part of a larger hybrid cloud.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

As another example, two blocks shown in succession may in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. Each block in the flowchart or block diagrams may represent a module, segment, or portion of instructions, which comprises one or more executable instructions for implementing the specified logical function(s).

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” “one arrangement,” “an arrangement,” “one aspect,” “an aspect,” or similar language means that a particular feature, structure, or characteristic described in connection with the embodiment is included in at least one embodiment described within this disclosure. Thus, appearances of the phrases “one embodiment,” “an embodiment,” “one arrangement,” “an arrangement,” “one aspect,” “an aspect,” and similar language throughout this disclosure may but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “if,” “when,” “upon,” “in response to,” and the like are not to be construed as indicating a particular operation is optional. Rather, use of these terms indicate that a particular operation is conditional. For example and by way of a hypothetical, the language of “performing operation A upon B” does not indicate that operation A is optional. Rather, this language indicates that operation A is conditioned upon B occurring.

The foregoing description is just an example of embodiments of the invention, and variations and substitutions. While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

What is claimed is:

1. A method of automatically generating business rules to be employed by a business rule management system, comprising:
identifying a plurality of external data sources from which to receive data updates;
obtaining, from at least one of the plurality of external data sources, a data update relevant to a collection of business rules;
performing, using a contextual analysis engine, a contextual analysis of the data update;
generating, using a machine learning engine and based upon the contextual analysis of the data update, an update to the collection of business rules to form an updated collection of business rules;
modifying the machine learning engine based upon feedback received on the update to the collection of business rules; and
forwarding the updated collection of business rules to the business rule management system.

2. The method of claim 1, wherein
the update to the collection of business rules includes a modification to a preexisting business rule.

3. The method of claim 1, wherein
the update to the collection of business rules includes a creation of a new business rule.

4. The method of claim 1, wherein
the contextual analysis includes performing, using a natural language processing engine, natural language processing on the data update.

5. The method of claim 1, wherein
the updated collection of business rules are implemented using a business process management system.

6. The method of claim 1, wherein
the plurality of external data sources includes a website, and
the obtaining the data update includes crawling the website for the data update.

7. The method of claim 1, wherein
the obtaining the data update includes receiving an electronic document from at least one of the plurality of external data sources.

8. The method of claim 1, wherein
the feedback includes an indication as to whether the update to the collection of business rules is approved.

9. A computer hardware system for automatically generating business rules to be employed by a business rule management system, comprising:
a hardware processor configured to perform the following executable operations:
identifying a plurality of external data sources from which to receive data updates;
obtaining, from at least one of the plurality of external data sources, a data update relevant to a collection of business rules;
performing, using a contextual analysis engine, a contextual analysis of the data update;
generating, using a machine learning engine and based upon the contextual analysis of the data update, an update to the collection of business rules to form an updated collection of business rules;
modifying the machine learning engine based upon feedback received on the update to the collection of business rules; and
forwarding the updated collection of business rules to the business rule management system.

10. The system of claim 9, wherein
the update to the collection of business rules includes a modification to a preexisting business rule.

11. The system of claim 9, wherein
the update to the collection of business rules includes a creation of a new business rule.

12. The system of claim 9, wherein
the contextual analysis includes performing, using a natural language processing engine, natural language processing on the data update.

13. The system of claim 9, wherein
the updated collection of business rules are implemented using a business process management system.

14. The system of claim 9, wherein
the plurality of external data sources includes a website, and
the obtaining the data update includes crawling the website for the data update.

15. The system of claim 9, wherein
the obtaining the data update includes receiving an electronic document from at least one of the plurality of external data sources.

16. The system of claim 9, wherein
the feedback includes an indication as to whether the update to the collection of business rules is approved.

17. A computer program product, comprising:
a computer readable storage medium having stored therein program code for automatically generating business rules to be employed by a business rule management system,
the program code, which when executed by a computer hardware system, cause the computer hardware system to perform:
identifying a plurality of external data sources from which to receive data updates;
obtaining, from at least one of the plurality of external data sources, a data update relevant to a collection of business rules;
performing, using a contextual analysis engine, a contextual analysis of the data update;
generating, using a machine learning engine and based upon the contextual analysis of the data update, an update to the collection of business rules to form an updated collection of business rules;
modifying the machine learning engine based upon feedback received on the update to the collection of business rules; and
forwarding the updated collection of business rules to the business rule management system.

18. The computer program product of claim 17, wherein
the contextual analysis includes performing, using a natural language processing engine, natural language processing on the data update.

19. The computer program product of claim 17, wherein
the plurality of external data sources includes a website, and
the obtaining the data update includes crawling the website for the data update.

20. The computer program product of claim 17, wherein
the feedback includes an indication as to whether the update to the collection of business rules is approved.
